(19) United States
(12) Patent Application Publication
(10) Pub. No.: US 2010/0261465 A1
(43) Pub. Date: Oct. 14, 2010

(54) METHODS AND SYSTEMS FOR CELL PHONE INTERACTIONS

(76) Inventors: Geoffrey B. Rhoads, West Linn, OR (US); Nicole Rhoads, West Linn, OR (US)

Correspondence Address: DIGIMARC CORPORATION, 9405 SW GEMINI DRIVE, BEAVERTON, OR, 97008, US

(21) Appl. No.: 12/498,709

(22) Filed: Jul. 7, 2009

Related U.S. Application Data
(60) Provisional application No. 61/169,266, filed on Apr. 14, 2009.

(51) Int. Cl. H04M 3/00

(52) U.S. Cl. 455/420

(57) ABSTRACT

Integrating wireless capability into a device (e.g., a thermostat, a parking meter, a hotel alarm clock, etc.), effectively adds to the device a graphical user interface (GUI) capability. The user's cell phone can be employed for interaction with the device via such a GUI. In one particular arrangement, a cell phone camera captures an image of a thermostat, from which an identifier (e.g., a steganographic digital watermark) is decoded and used to access a corresponding record at a remote server. The server in this arrangement causes a JavaScript application to be returned to the cell phone—which may correspond both to the thermostat which is to be controlled, and to the cell phone that is to control it. An exemplary GUI takes the form of a graphical overlay—presented in registered alignment atop the camera-captured image of the device. Once the application establishes an initial session between the phone and the controlled device, the phone may later recall the GUI to allow further device interaction—such as changing the thermostat temperature from the user's desk (or adding time to a parking meter from across town). The interfaces may be customized, e.g., for user preferences, and for different specific task-oriented interactions. By such technology, a user's cell phone serves as multi-purpose interface for dealing with a variety of wireless-equipped devices.

### RELATED APPLICATION DATA

This application is a non-provisional that claims priority to provisional application 61/169,266, filed Apr. 14, 2009, the disclosure of which is incorporated herein by reference.

### TECHNICAL FIELD

The present technology relates to cell phones and the like, and their interactions with other devices.

### INTRODUCTION

The present technology builds on, and extends, technology disclosed in prior patent application Ser. Nos. 12/271,692, filed Nov. 14, 2008, and 12/484,115, filed Jun. 12, 2009. The reader is thus directed to those applications (which are incorporated herein by reference), which serve to detail arrangements in which applicants intend the present technology to be applied, and that technically supplement the present disclosure.

The just-cited applications detail intuitive computing technologies—cell phones that can see and/or hear, and that respond appropriately to the sensed environment.

Most of the examples detailed in those applications involved sensing objects that have no means to communicate. A statue and a drill are examples. The present application more particularly considers such technologies applied to objects that are equipped to communicate, or that can be so-equipped. Simple examples are WiFi-equipped thermostats and parking meters, and hotel bedside clocks equipped with Bluetooth.

Consider a user who drives to her office downtown. Finding a vacant parking space, she points her cell phone at the parking meter. A virtual user interface (UI) near-instantly appears on the screen of the cell phone—allowing her to buy two hours of time from the meter. Inside the office building the woman finds the conference room chilly, and points the cell phone at a thermostat. An instant later a different virtual user interface appears on the cell phone—permitting her to change the thermostat's settings. Ten minutes before the parking meter is about to run out of time, the cell phone chimes, and again presents a UI for the parking meter. The user buys another hour of time.

For industrial users and other applications where the security of interaction is important, or applications where anonymity is important, various levels of security and access privileges can be incorporated into an interactive session between a user's mobile device and an object being imaged. A first level includes simply overtly or covertly encoding contact instructions in the surface features of an object, such as an IP address; a second level includes presenting public-key information to a device, either explicitly through overt symbology or more subtly through digital watermarking; and a third level where unique patterns or digital watermarking can only be acquired by actively taking a photograph of an object.

The interface presented on the user's cell phone may be customized, in accordance with user preferences, and/or to facilitate specific task-oriented interactions with the device (e.g., a technician may pull up a “debug” interface for a thermostat, while an office worker may pull up a temperature setting control).

Anywhere there is a physical object or device that incorporates elements such as displays, buttons, dials or other such features meant for physical interaction with the object or device, such costs may not be necessary. Instead, their functionality may be duplicated by a mobile device that actively and visually interacts with the object or device.

By incorporating a wireless chip into a device, a manufacturer effectively enables a mobile GUI for that device.

According to one aspect, the present technology includes using a mobile phone to obtain identification information corresponding to a device. By reference to the obtained identification information, application software corresponding to said device is then identified, and downloaded to the mobile phone. This application software is then used in facilitating user interaction with the device. By such arrangement, the mobile phone serves as a multi-function controller—adapted to control a particular device through use of application software identified by reference to information corresponding to that device.

According to another aspect, the present technology includes using a mobile phone to sense information from a housing of a device. Through use of this sensed information, other information is encrypted using a public key corresponding to the device.

According to still another aspect, the present technology includes using a mobile phone to sense analog information from a device. This sensed analog information is converted to digital form, and corresponding data is transmitted from the cell phone. This transmitted data is used to confirm user proximity to the device, before allowing a user to interact with the device using the mobile phone.

According to yet another aspect, the present technology includes using a user interface on a user's cell phone to receive an instruction relating to control of a device. This user interface is presented on a screen of the cell phone in combination with a cell phone-captured image of the device. Information corresponding to the instruction is signaled to the user, in a first fashion, while the instruction is pending; and in a second fashion once the instruction has been successfully performed.

According to still another aspect, the present technology includes initializing a transaction with a device, using a user interface presented on a screen of a user cell phone, while the user is in proximity to the device. Later, the cell phone is used for a purpose unrelated to the device. Still later, the user interface is recalled and used to engage in a further transaction with the device.

According to yet another aspect, the present technology includes a mobile phone including a processor, a memory, a sensor, and a display. Instructions in the memory configure the processor to enable the following acts: sense information from a proximate first device; download first user interface software corresponding to the first device, by reference to the sensed information; interact with the first device by user interaction with the downloaded first user interface software; recall from the memory second user interface software corresponding to a second device, the second user interface software having been earlier downloaded to the mobile phone; and interact with the second device by user interaction with the recalled second user interface software, regardless of whether the user is proximate to said second device.

According to still another aspect, the present technology includes a mobile phone including a processor, a memory, and a display. Instructions in the memory configure the processor to present a user interface that allows a user to select between several other device-specific user interfaces stored in memory, for using the mobile phone to interact with plural different external devices.

The foregoing and many other aspects, features and advantages of the present technology will be more readily apparent from the following detailed description, which proceeds by reference to the accompanying drawings.

### BRIEF DESCRIPTION OF THE DRAWINGS

FIG. 1 is a block diagram of a prior art thermostat.

FIG. 2 is an exterior view of the thermostat of FIG. 1.

FIG. 3 is a block diagram of a thermostat employing certain aspects of the present technology.

FIG. 4 is a block diagram of a cell phone embodying certain aspects of the present technology.

FIG. 5 is a block diagram by which certain operations of the thermostat of FIG. 3 are explained.

FIG. 6 shows a cell phone display depicting an image captured from a thermostat, onto which is overlaid certain touch-screen targets that the user can touch to increment or decrement the thermostat temperature.

FIG. 7 is similar to FIG. 6, but shows a graphical user interface for use on a phone without a touch-screen.

FIG. 8 is a block diagram of an alarm clock employing aspects of the present technology.

FIG. 9 shows a screen of an alarm clock user interface that may be presented on a cell phone, in accordance with one aspect of the technology.

FIG. 10 shows a screen of a user interface, detailing nearby devices that may be controlled through use of the cell phone.

### DETAILED DESCRIPTION

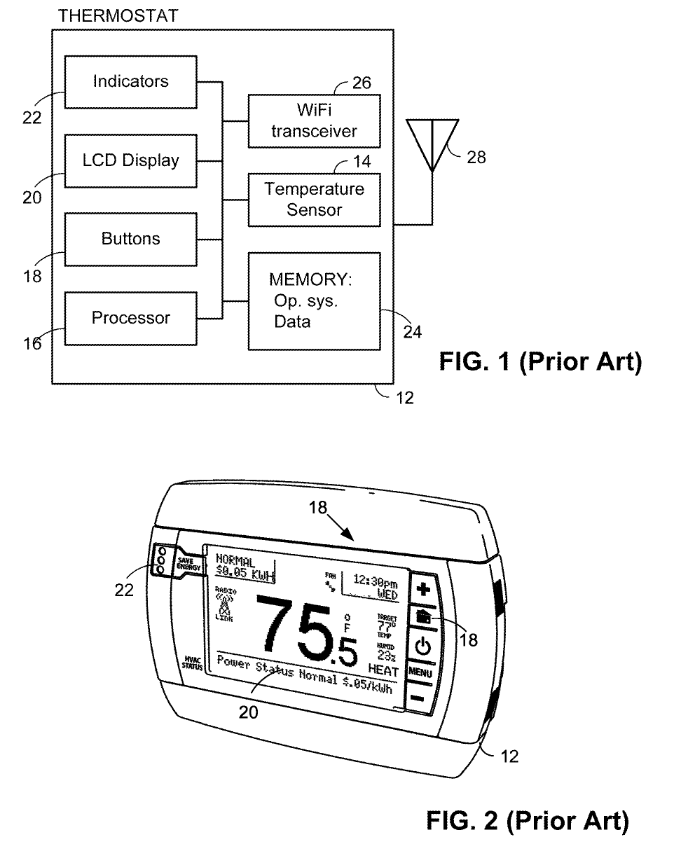

FIGS. 1 and 2 show a prior art WiFi-equipped thermostat 12. Included are a temperature sensor 14, a processor 16, and a user interface 18. The user interface includes various buttons 18, an LCD display screen 20, and one or more indicator lights 22. A memory 24 stores programming and data for the thermostat. Finally, a WiFi transceiver 26 and antenna 28 allow communication with remote devices. (Depicted thermostat 12 is available from the Radio Thermostat Company of America as model CT80. The WiFi transceiver comprises the GainSpan GS1010 SoC (System on Chip) device.)

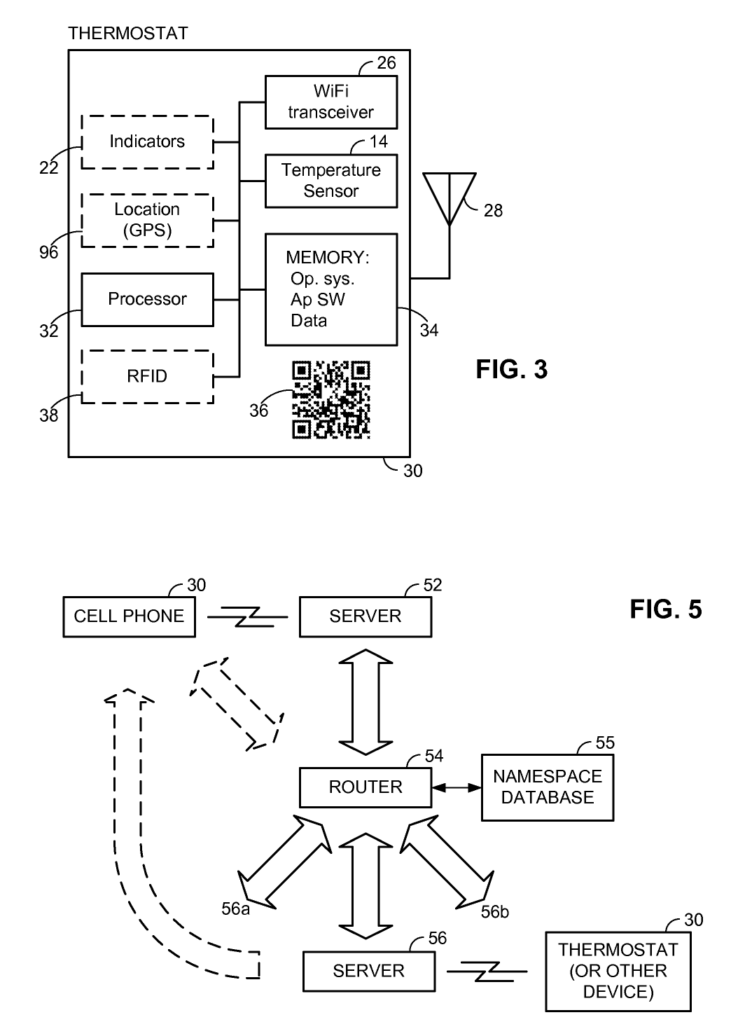

FIG. 3 shows a similar thermostat 30, but embodying principles according to the present technology. Like thermostat 12, thermostat 30 includes a temperature sensor 14 and a processor 32. The memory 34 may store the same programming and data as memory 24. However, this memory 34 includes a bit more software to support the functionality described below. (For expository convenience, the software associated with the present technology is given a name: ThingPipe software. The thermostat memory thus has ThingPipe code that cooperates with other code on other devices—such as cell phones—to implement the detailed functionality.

Thermostat 30 can include the same user interface 18 as thermostat 12. However, significant economies may be achieved by omitting many of the associated parts, such as the LCD display and buttons. The depicted thermostat includes thus only indicator lights 22, and even these may be omitted.

Thermostat 30 also includes an arrangement through which its identity can be sensed by a cell phone. The WiFi emissions from the thermostat may be employed (e.g., by the device's MAC identifier). However, other means are preferred, such as indicia that can be sensed by the camera of a cell phone.

A steganographic digital watermark is one such indicia that can be sensed by a cell phone camera. Digital watermark technology is detailed in the assignee's patents, including U.S. Pat. No. 6,590,996 and U.S. Pat. No. 6,947,571. The watermark data can be encoded in a texture pattern on the exterior of the thermostat, on an adhesive label, on pseudo wood-grain trim on the thermostat, etc. (Since steganographic encoding is hidden, it is not depicted in FIG. 3.)

Another suitable indicia is a 1D or 2D bar code or other overt symbology, such as the bar code 36 shown in FIG. 3. This may be printed on the thermostat housing, applied by an adhesive label, etc.

Still other means for identifying the thermostat may be employed, such as an RFID chip 38. Another is a short range wireless broadcast—such as by Bluetooth—of a Bluetooth identifier, or a network service discovery protocol (e.g., Bonjour). Object recognition, by means such as image fingerprinting, or scale-invariant feature transformation such as SIFT, can also be used. So can other identifiers—manually entered by the user, or identified through navigating a directory structure of possible devices. The artisan will recognize many other alternatives.

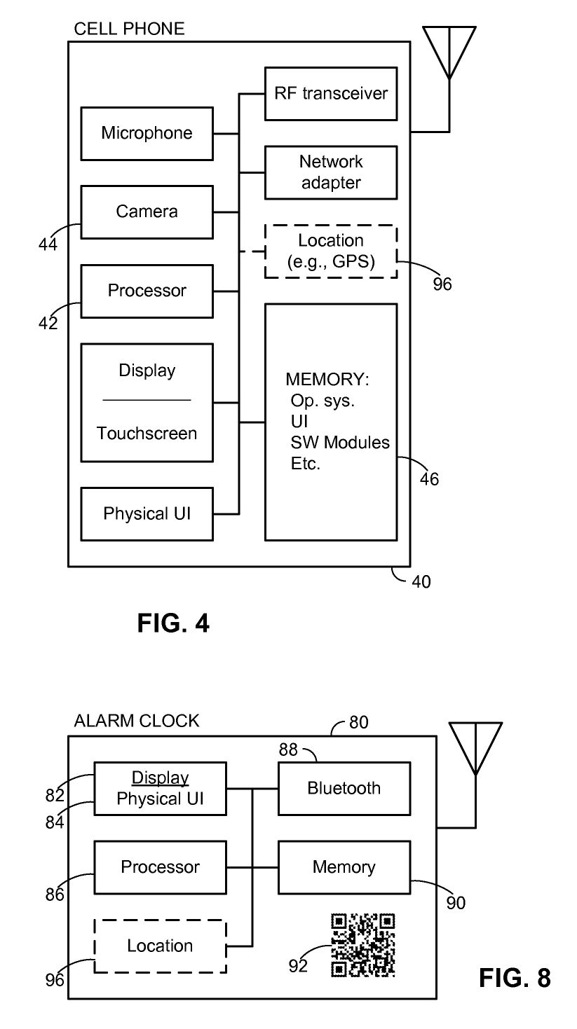

FIG. 4 shows an exemplary cell phone 40, such as the Apple iPhone device. Included are conventional elements including a processor 42, a camera 44, a microphone, an RF transceiver, a network adapter, a display, and a user interface. The user interface includes physical controls as well as a touch-screen sensor. (Details of the user interface, and associated software, are provided in Apple's patent publication 20080174570.) The memory 46 of the phone includes the usual operating system and application software. In addition it includes ThingPipe software for performing the functions detailed in this specification.

Turning to operation of the illustrated embodiment, a user captures an image depicting the digitally-watermarked thermostat 30 using the cell phone camera 44. The processor 42 in the cell phone pre-processes the captured image data (e.g., by applying a Wiener filter or other filtering, and/or compressing the image data), and wirelessly transmits the processed data by to a remote server 52 (FIG. 5)—together with information identifying the cell phone. (This can be part of the functionality of the ThingPipe code in the cell phone.) The wireless communication can be by WiFi to a nearby wireless access point, and then by internet to the server 52. Or the cell phone network can be employed, etc.

Server 52 applies a decoding algorithm to the processed image data received from the cell phone, extracting steganographically encoded digital watermark data. This decoded data—which may comprise an identifier of the thermostat—is transmitted by internet to a router 54, together with the information identifying the cell phone.

Router 54 receives the identifier and looks it up in a namespace database 55. The namespace database 55 examines the most significant bits of the identifier, and conducts a query to identify a particular server responsible for that group of identifiers. The server 56 thereby identified by this process has data pertaining to that thermostat. (Such an arrangement is akin to the Domain Name Servers employed in internet routing. U.S. Pat. No. 6,947,571 has additional disclosure on how watermarked data can be used to identify a server that knows what to do with such data.)

Router 54 polls identified server 56 for information. For example, router 54 may solicit from server 56 current data relating to the thermostat (e.g., current temperature setpoint and ambient temperature, which server 56 may obtain from the thermostat by a link that includes WiFi). Additionally, server 56 is requested to provide information about a graphical user interface suitable for display on the Apple iPhone 40 to control that particular thermostat. This information may comprise, for example, a JavaScript application that runs on the cell phone 40, and presents a GUI suited for use with the thermostat. This information is passed back to the cell phone—directly, or through server 52. The returned information may include the IP address of the server 56, so that the cell phone can thereafter exchange data directly with server 56.

The ThingPipe software in the cell phone 40 responds to the received information by presenting the graphical user interface for thermostat 30 on its screen. This GUI can include the ambient and setpoint temperature for the thermostat—whether received from the server 56, or directly (such as by WiFi) from the thermostat. Additionally, the presented GUI includes controls that the user can operate to change the settings. To raise the setpoint temperature, the user touches a displayed control corresponding to this operation (e.g., an “Increase Temperature” button). The setpoint temperature presented in the UI display immediately increments in response to the user's action—perhaps in flashing or other distinctive fashion to indicate that the request is pending.

The user's touch also causes the ThingPipe software to transmit corresponding data from the cell phone 40 to the thermostat (which transmission may include some or all of the other devices shown in FIG. 5, or it may go directly to the thermostat—such as by WiFi). Upon receipt of this data, the thermostat increases its set temperature per the user's instructions. It then issues a confirmatory message that is relayed back from the thermostat to the cell phone. On receipt of the confirmatory message, the flashing of the incremented temperature indicator ceases, and the setpoint temperature is then displayed in static form. (Other arrangements are of course possible. For example, the confirmatory message may be rendered to the user as a visible signal—such as the text “Accepted” presented on the display, or an audible chime, or a voice saying “OK.”)

In one particular embodiment, the displayed UI is presented as an overlay on the screen of the cell phone, atop the image earlier captured by the user depicting the thermostat. Features of the UI are presented in registered alignment with any corresponding physical controls (e.g., buttons) shown in the captured image. Thus, if the thermostat has Temperature Up and Temperature Down buttons (e.g., the “+” and “−” buttons in FIG. 2), the graphical overlay may outline these in the displayed image in a distinctive format, such as with scrolling dashed red lines. These are the graphical controls that the user touches to raise or lower the setpoint temperature.

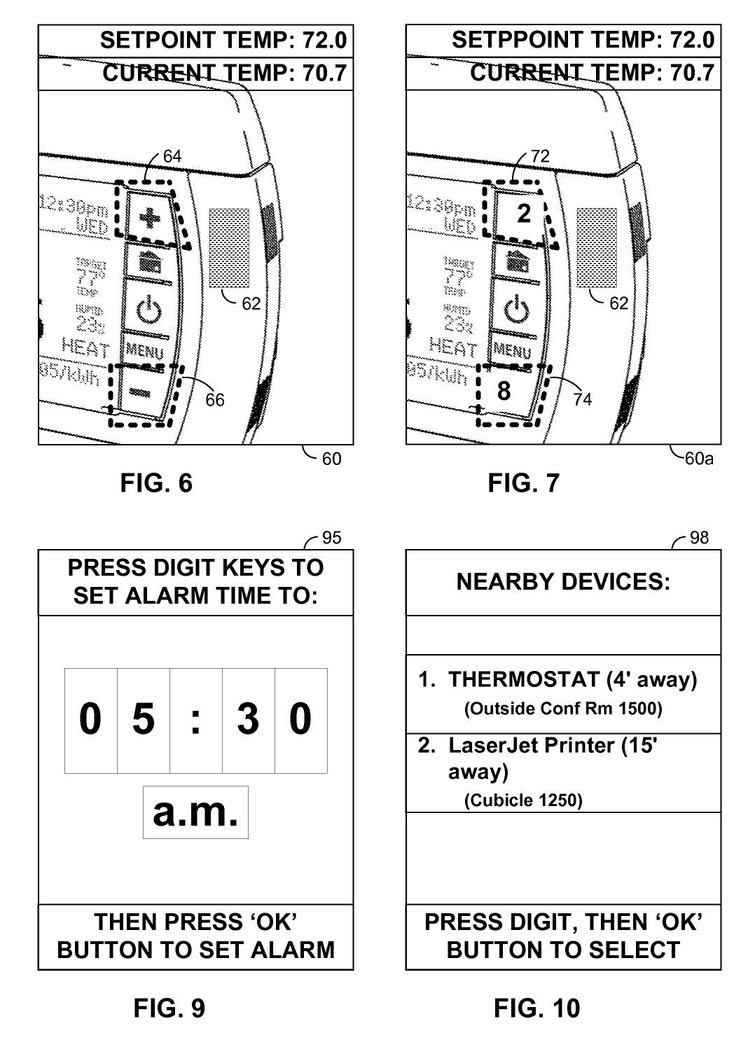

This is shown schematically by FIG. 6, in which the user has captured an image 60 of part of the thermostat. Included in the image is at least a part of the watermark 62 (shown to be visible for sake of illustration). By reference to the watermark, and data obtained from server 56 about the layout of the thermostat, the cell phone processor overlays scrolling dashed lines atop the image—outlining the “+” and “−” buttons. When the phone's touch-screen user interface senses user touches in these outlined regions, it reports same to the ThingPipe software in the cell phone. It, in turn, interprets these touches as commands to increment or decrement the thermostat temperature, and sends such instructions to the thermostat (e.g., through server 52 and/or 56). Meanwhile, it increments a “SET TEMPERATURE” graphic that is also overlaid atop the image, and causes it to flash until the confirmatory message is received back from the thermostat.

The registered overlay of a graphical user interface atop captured image data is enabled by the encoded watermark data on the thermostat housing. Calibration data in the watermark permits the scale, translation and rotation of the thermostat's placement within the image to be precisely determined. If the watermark is reliably placed on the thermostat in a known spatial relationship with other device features (e.g., buttons and displays), then the positions of these features within the captured image can be determined by reference to the watermark. (Such technology is further detailed in applicant's published patent application 20080300011.)

If the cell phone does not have a touch-screen, the registered overlay of a UI may still be used. However, instead of providing a screen target for the user to touch, the outlined buttons presented on the cell phone screen can indicate corresponding buttons on the phone's keypad that the user should press to activate the outlined functionality. For example, an outlined box around the “+” button may periodically flash orange with the number “2”—indicating that the user should press the “2” button on the cell phone keypad to increase the thermostat temperature setpoint. (The number “2” is flashed atop the “+” portion of the image—permitting the user to discern the “+” marking in the captured image when the number is not being flashed.) Similar, an outlined box around the “−” button may periodically flash orange with the number “8”—indicating that the user should press the “8” button on the cell phone keypad to decrement the thermostat temperature setpoint. See FIG. 7 at 72, 74.

Although overlay of the graphical user interface onto the captured image of the thermostat, in registered alignment, is believed easiest to implement through use of watermarks, other arrangements are possible. For example, if the size and scale of a barcode, and its position on the thermostat, are known, then the locations of the thermostat features for overlay purposes can be geometrically determined. Similarly with an image fingerprint-based approach (including SIFT). If the nominal appearance of the thermostat is known (e.g., by server 56), then the relative locations of features within the captured image can be discerned by image analysis.

In one particular arrangement, the user captures a frame of imagery depicting the thermostat, and this frame is buffered for static display by the phone. The overlay is then presented in registered alignment with this static image. If the user moves the camera, the static image persists, and the overlaid UI is similarly static. In another arrangement, the user captures a stream of images (e.g., video capture), and the overlay is presented in registered alignment with features in the image even if they move from frame to frame. In this case the overlay may move across the screen, in correspondence with movement of the depicted thermostat within the cell phone screen. Such an arrangement can allow the user to move the camera to capture different aspects of the thermostat—perhaps revealing additional features/controls. Or it permits the user to zoom the camera in so that certain features (and the corresponding graphically overlays) are revealed, or appear at a larger scale on the cell phone's touchscreen display. In such a dynamic overlay embodiment, the user may selectively freeze the captured image at any time, and then continue to work with the (then static) overlaid user interface control—without regard to keeping the thermostat in the camera's field of view.

If the thermostat 30 is of the sort that has no visible controls, then the UI displayed on the cell phone can be of any format. If the cell phone has a touch-screen, thermostat controls may be presented on the display. If there is no touch-screen, the display can simply present a corresponding menu. For example, it can instruct the user to press “2” to increase the temperature setpoint, press “8” to decrease the temperature setpoint, etc.

After the user has issued an instruction via the cell phone, the command is relayed to the thermostat as described above, and a confirmatory message is desirably returned back—for rendering to the user by the ThingPipe software.

It will be recognized that the displayed user interface is a function of the device with which the phone is interacting (i.e., the thermostat), and may also be a function of the capabilities of the cell phone itself (e.g., whether it has a touch-screen, the dimension of the screen, etc). Instructions and data enabling the cell phone's ThingPipe software to create these different UIs may be stored at the server 56 that administers the thermostat, and is delivered to the memory 46 of the cell phone with which the thermostat interacts.

Another example of a device that can be controlled by the present technology is a WiFi-enabled parking meter. The user captures an image of the parking meter with the cell phone camera (e.g., by pressing a button, or the image capture may be free-running—such as every second or several). Processes occur generally as detailed above. The ThingPipe software processes the image data, and router 54 identifies a server 56a responsible for ThingPipe interactions with that parking meter. The server returns UI instructions, optionally with status information for that meter (e.g., time remaining; maximum allowable time). These data are displayed on the cell phone UI, e.g., overlaid on the captured image of the cell phone, together with controls/instructions for purchasing time.

The user interacts with the cell phone to add two hours of time to the meter. A corresponding payment is debited, e.g., from the user's credit card account—stored as encrypted profile information in the cell phone or in a remote server. (Online payment systems, including payment arrangements suitable for use with cell phones, are well known, so are not belabored here.) The user interface on the cell phone confirms that the payment has been satisfactorily made, and indicates the number of minutes purchased from the meter. A display at the streetside meter may also reflect the purchased time.

The user leaves the meter and attends to other business, and may use the cell phone for other purposes. The cell phone may lapse into a low power mode—darkening the screen. However, the downloaded application software tracks the number of minutes remaining on the meter. It can do this by periodically querying the associated server for the data. Or it can track the time countdown independently. At a given point, e.g., with ten minutes remaining, the cell phone sounds an alert.

Looking at the cell phone, the user sees that the cell phone has been returned to its active state, and the meter UI has been restored to the screen. The displayed UI reports the time remaining, and gives the user the opportunity to purchase more time. The user purchases another 30 minutes of time. The completed purchase is confirmed on the cell phone display—showing 40 minutes of time remaining. The display on the streetside meter can be similarly updated.

Note that the user did not have to physically return to the meter to add the time. A virtual link persisted, or was re-established, between the cell phone and the parking meter—even though the user may have walked a dozen blocks, and taken an elevator up multiple floors. The parking meter control is as close as the cell phone.

(Although not particularly detailed, the block diagram of the parking meter is similar to that of the thermostat of FIG. 3, albeit without the temperature sensor.)

Consider a third example—a bedside alarm clock in a hotel. Most travelers know the experience of being confounded by the variety of illogical user interfaces presented by such clocks. It's late; the traveler is groggy from a long flight, and now faces the chore of figuring out which of the black buttons on the black clock must be manipulated in the dimly lit hotel room to set the alarm clock for 5:30 a.m. Better, it would be, if such devices could be controlled by an interface presented on the user's cell phone—preferably a standardized user interface that the traveler knows from repeated use.

FIG. 8 shows an alarm clock 80 employing aspects of the present technology. Like other alarm clocks it includes a display 82, a physical UI 84 (e.g., buttons), and a controlling processor 86. This clock, however, also includes a Bluetooth wireless interface 88, and a memory 90 in which are stored ThingPipe and Bluetooth software for execution by the processor. The clock also has means for identifying itself, such as a digital watermark or barcode, as described above.

As in the earlier examples, the user captures an image of the clock. An identifier is decoded from the imagery, either by the cell phone processor, or by a processor in a remote server 52b. From the identifier, the router identifies a further server 56b that is knowledgeable about such clocks. The router passes the identifier to the further server, together with the address of the cell phone. The server uses the decoded watermark identifier to look up that particular clock, and recall instructions about its processor, display, and other configuration data. It also provides instructions by which the particular display of cell phone 30 can present a standardized clock interface, through which the clock parameters can be set. The server packages this information in a file, which is transmitted back to the cell phone.

The cell phone receives this information, and presents the user interface detailed by server 56b on the screen. It is a familiar interface—appearing each time this cell phone is used to interact with a hotel alarm clock—regardless of the clock's model or manufacturer. (In some cases the phone may simply recall the UI from a UI cache, e.g., in the cell phone, since it is used frequently.)

Included in the UI is a control “LINK TO CLOCK.” When selected, the cell phone communicates, by Bluetooth, with the clock. (Parameters sent from server 56b may be required to establish the session.) Once linked by Bluetooth, the time displayed on the clock is presented on the cell phone UI, together with a menu of options.

One of the options presented on the cell phone screen is “SET ALARM.” When selected, the UI shifts to a further screen 95 (FIG. 9) inviting the user to enter the desired alarm time by pressing the digit keys on the phone's keypad. (Other paradigms can naturally be used, e.g., flicking displayed numbers on a touch-screen interface to have them spin until the desired digits appear, etc.) When the desired time has been entered, the user presses the OK button on the cell phone keypad to set the time.

As before, the entered user data (e.g., the alarm time) flashes while the command is transmitted to the device (in this case by Bluetooth), until the device issues a confirmatory signal—at which point the displayed data stops flashing.

In the clock, the instruction to set the alarm time to 5:30 a.m. is received by Bluetooth. The ThingPipe software in the alarm clock memory understands the formatting by which data is conveyed by the Bluetooth signal, and parses out the desired time, and the command to set the alarm. The alarm clock processor then sets the alarm to ring at the designated time.

Note that in this example, the cell phone and clock communicate directly—rather than through one or more intermediary computers. (The other computers were consulted by the cell phone to obtain the programming particulars for the clock but, once obtained, were not contacted further.)

Further note that in this example—unlike the thermostat—the user interface does not integrate itself (e.g., in registered alignment) with the image of the clock captured by the user. This refinement is omitted in favor of presenting a consistent user interface experience—independent of the particular clock being programmed.

As in the earlier examples, a watermark is preferred by the present applicants to identify the particular device. However, any other known identification technology can be used, including those noted above.

Nothing has yet been said about the optional location modules 96 in each of the detailed devices. One such module is a GPS receiver. Another emerging technology suitable for such modules relies on radio signals that are that commonly exchanged between devices (e.g., WiFi, cellular, etc.). Given several communicating devices, the signals themselves—and the imperfect digital clock signals that control them—form a reference system from which both highly accurate time and position can be abstracted. Such technology is detailed in laid-open international patent publication WO08/073,347.

Knowing the locations of the devices allows enhanced functionality to be realized. For example, it allows devices to be identified by their position (e.g., unique latitude/longitude/elevation coordinates)—rather than by an identifier (e.g., watermarked or otherwise). Moreover, it allows proximity between a cell phone and other ThingPipe devices to be determined.

Consider the example of the user who approaches a thermostat. Rather than capturing an image of the thermostat, the user may simply launch the cell phone's ThingPipe software (or it may already be running in the background). This software communicates the cell phone's current position to server 52, and requests identification of other ThingPipe-enabled devices nearby. (“Nearby” is, of course, dependent on the implementation. It may be, for example, 10 feet, 10 meters, 50 feet, 50 meters, etc. This parameter can be defined by the cell phone user, or a default value can be employed). Server 52 checks a database identifying the current locations of other ThingPipe-enabled devices, and returns data to the cell phone identifying those that are nearby. A listing 98 (FIG. 10) is presented on the cell phone screen—including distance from the user. (If the cell phone's location module includes a magnetometer, or other means to determine the direction the device is facing, the displayed listing can also include directional clues with the distance, e.g., “4′ to your left.”)

The user selects the THERMOSTAT from the displayed list (e.g., by touching the screen—if a touch-screen, or entering the associated digit on a keypad). The phone then establishes a ThingPipe session with the thus-identified device, as detailed above. (In this example the thermostat user interface is not overlaid atop an image of the thermostat, since no image was captured.)

In the three examples detailed above, there is the question of who should be authorized to interact with the device, and for how long?

In the case of a hotel alarm clock, authorization is not critical. Anyone in the room—able to sense the clock identifier—may be deemed authorized to set the clock parameters (e.g., current time, alarm time, display brightness, alarm by buzz or radio, etc.). This authorization should persist, however, only so long as the user is within the vicinity of the clock (e.g., within Bluetooth range). It would not do to have a former guest reprogram the alarm while a guest the following night is sleeping.

In the case of the parking meter, authorization may again be anyone who approaches the meter and captures a picture (or otherwise senses its identifier from short range).

As noted, in the parking meter case the user is able to recall the corresponding UI at a later time and engage in further transactions with the device. This is fine, to a point. Perhaps twelve hours from the time of image capture is a suitable time interval within which a user can interact with the meter. (No harm done if the user adds time later in the twelve hours—when someone else is parked in the space.) Alternatively, the user's authorization to interact with the device may be terminated when a new user initiates a session with the meter (e.g., by capturing an image of the device and initiating a transaction of the sort identified above).

A memory storing data setting the user's authorization period can be located in the meter, or it can be located elsewhere, e.g., in server 56a. A corresponding ID for the user would also normally be stored. This can be the user's telephone number, a MAC identifier for the phone device, or some other generally unique identifier.

In the case of the thermostat, there may be stricter controls about who is authorized to change the temperature, and for how long. Perhaps only supervisors in an office can set the temperature. Other personnel may be granted lesser privileges, e.g., to simply view the current ambient temperature. Again, a memory storing such data can be located in the thermostat, in the server 56, or elsewhere.

These three examples are simple, and the devices being controlled are of small consequence. In other applications, higher security would naturally be a concern. The art of authentication is well developed, and an artisan can draw from known techniques and technologies to implement an authentication arrangement suitable for the particular needs of any given application.

If the technology becomes widespread, a user may need to switch between several on-going ThingPipe sessions. The ThingPipe application can have a “Recent UI” menu option that, when selected, summons a list of pending or recent sessions. Selecting any recalls the corresponding UI, allowing the user to continue an earlier interaction with a particular device.

Physical user interfaces—such as for thermostats and the like—are fixed. All users are presented with the same physical display, knobs, dials, etc. All interactions must be force-fit into this same physical vocabulary of controls.

Implementations of the present technology can be more diverse. Users may have stored profile settings—customizing cell phone UIs to their particular preferences—globally, and/or on a per-device basis. For example, a color-blind user may so-specify, causing a gray scale interface to always be presented—instead of colors which may be difficult for the user to discriminate. A person with farsighted vision may prefer that information be displayed in the largest possible font—regardless of aesthetics. Another person may opt for text to be read from the display, such as by a synthesized voice. One particular thermostat UI may normally present text indicating the current date; a user may prefer that the UI not be cluttered with such information, and may specify—for that UI—that no date information should be shown.

The user interface can also be customized for specific task-oriented interactions with the object. A technician may invoke a “debug” interface for a thermostat, in order to trouble-shoot an associated HVAC system; an office worker may invoke a simpler UI that simply presents the current and set-point temperatures.

Just as different users may be presented with different interfaces, different levels of security and access privileges can also be provided.

A first security level includes simply encoding (covertly or overtly) contact instructions for the object in the surface features of the object, such as an IP address. The session simply starts with the cell phone collecting contact information from the device. (Indirection may be involved; the information on the device may refer to a remote repository that stores the contact information for the device.)

A second level includes public-key information, explicitly present on the device through overt symbology, more subtly hidden through steganographic digital watermarking, indirectly accessed, or otherwise-conveyed. For example, machine readable data on the device may provide the device's public key—with which transmissions from the user must be encrypted. The user's transmissions may also convey the user's public key—by which the device can identify the user, and with which data/instructions returned to the cell phone are encrypted.

Such arrangement allows a secure session with the device. A thermostat in a mall may use such technology. All passers-by may be able to read the thermostat's public key. However, the thermostat may only grant control privileges to certain users—identified by their respective public keys.

A third level includes preventing control of the device unless the user submits unique patterns or digital watermarking that can only be acquired by actively taking a photograph of the device. That is, it is not simply enough to send an identifier corresponding to the device. Rather, minutiae evidencing the user's physical proximity to the device must also be captured and transmitted. Only by capturing a picture of the device can the user obtain the necessary data; the image pixels essentially prove the user is nearby and took the picture.

To avoid spoofing, all patterns previously submitted may be cached—either at a remote server, or at the device, and checked against new data as it is received. If the identical pattern is submitted a second time, it may be disqualified—as an apparent playback attack (i.e., each image of the device should have some variation at the pixel level). In some arrangements the appearance of the device is changed over time (e.g., by a display that presents a periodically-changing pattern of pixels), and the submitted data must correspond to the device within an immediately preceding interval of time (e.g., 5 seconds, or 5 minutes).

In a related embodiment, any analog information (appearance, sound, temperature, etc.) can be sensed from the device or its environment, and used to establish user proximity to the device. (The imperfect representation of the analog information, when converted to digital form, again can be used to detect replay attacks.)

One simple application of this arrangement is a scavenger hunt—where taking a picture of a device provides the user's presence at the device. A more practical application is industrial settings, where there is concern about people remotely trying to access devices without physically being there.

A great number of variations and hybrids of such arrangements will be evident to the artisan from the foregoing.

### Concluding Remarks

Having described and illustrated the principles of our technology with reference to various examples, it should be recognized that the technology is not so limited.

For example, while thermostats, parking meters and hotel alarm clocks were particularly detailed, it will be recognized that this technology can be employed in any context where electronic circuitry is or can be present. (A vehicle is another example. A cell phone can sense identifying information from the vehicle, and present a UI on which a back-seat passenger can adjust the climate control system, or audio/video entertainment system, etc.)

Similarly, while different of the detailed embodiments included different features, it should be understood that features disclosed in one embodiment can be used in the others. A great variety of combinations and permutations can thus be straightforwardly implemented—depending on the requirements of particular applications.

Although disclosed as complete systems, sub-combinations of the detailed arrangements are also separately contemplated.

While this disclosure has detailed particular ordering of acts, and particular combinations of elements, in the illustrative embodiments, it will be recognized that other contemplated methods may re-order acts (possibly omitting some and adding others), and other contemplated combinations may omit some elements and add others, etc.

Moreover, it will be recognized that the detailed technology can be included with other technologies—current and upcoming—to advantageous effect.

For example, applicants expect that cell phones and other portable systems will evolve to better anticipate users' needs and desires, based on context and other data. Thus, in the introductory example—the woman who drives downtown and interacts with a parking meter—the user shouldn't really have to instruct the cell phone what is desired. Context and other circumstances should make it clear.

Before arriving, the cell phone sensed that the woman was in the car: the cell phone processor was in wireless communication with one or more processors within the vehicle. It similarly tracked the route the user took, and inferred (from past data) where she was likely going. Moreover, the user's calendar application in the cell phone may have specified that she had an appointment at an office downtown. Regardless, by the time the car stopped, the cell phone should have anticipated that a next operation was interaction with a parking meter. Desirably, it would have polled server 52 or otherwise identified nearby parking meters as soon as the car was turned off, so that the user interface was presented on the cell phone screen before the user had removed her seatbelt. Knowing the length of the appointment, or recalling the user's behavior in prior circumstances, the UI should propose a likely amount of time for the user to purchase. Or it should do it itself. (An updated user interface paradigm should evolve which—instead of being tailored to a user issuing instructions—is tailored to allow the user to countermand earlier device-made instructions, for when the device makes incorrect guesses about a user's intent.)

Likewise through the day. Users should be able to choose to do less; and delegate their devices to do more.

While data is described as being stored or processed in certain devices, this is illustrative only. Data can be stored and processed anywhere (including “in the cloud”), and operations may be distributed among several devices. Thus, for example, references to a cell phone or a server performing a particular operation, or data being stored in a thermostat, are illustrative only. Other arrangements can of course be used.

Reference was made to Bonjour. Bonjour is Apple's trade name for its implementation of Zeroconf—a service discovery protocol. Bonjour locates devices within a local network, and identifies services that each offers, using multicast Domain Name System service records. This software is built into the Apple MAC OS X operating system, and is also included in the Apple “Remote” application for the iPhone, where it is used to establish connections to iTunes libraries via WiFi.

Bonjour services are implemented at the application level largely using standard TCP/IP calls, rather than in the operating system. Apple has made the source code of the Bonjour multicast DNS responder—the core component of service discovery—available as a Darwin open source project. The project provides source code to build the responder daemon for a wide range of platforms, including Mac OS X, Linux, *BSD, Solaris, and Windows. In addition, Apple provides a user-installable set of services called Bonjour for Windows, as well as Java libraries.

Bonjour can be employed to serve various functions in implementations of the present technology, including short range communications that identify devices, their parameters and functional abilities.

Other software can alternatively, or additionally, be used to exchange data between devices. Examples include Universal Plug and Play (UPnP) and its successor Devices Profile for Web Services (DPWS). These are other protocols implementing zero configuration networking services, through which devices can connect, identify themselves, advertise available capabilities to other devices, share information, etc.

The artisan is presumed to be familiar with such software tools.

While this specification frequently uses the term “cell phone,” this term is meant to be given a broad meaning and includes phones of various descriptions—including WiFi phones and others that may not—strictly speaking—use a “cell” network. As noted, the Apple iPhone is one example of a cell phone. Another is the T-Mobile G1—one of the Android phones. Other personal digital assistant devices, which include the functions of a computer, a music player, and/or a camera, etc., are also meant to be encompassed by the term “cell phone” as used in this specification—even if “phone” functionality is not provided.

The design of cell phones is familiar to the artisan. As indicated above, each typically includes one or more processors, one or more memories (e.g. RAM), storage (e.g., a disk or flash memory), a user interface (which may include, e.g., a keypad, a TFT LCD or OLED display screen, touch or other gesture sensors, a camera or other optical sensor, a microphone, etc., together with software instructions for providing a graphical user interface), and an interface for communicating with other devices (which may be wireless, as noted above, and/or wired, such as through an Ethernet local area network, a T-1 internet connection, etc). The other devices include many of these same elements.

The functionality detailed in this specification can be implemented by dedicated hardware, or by processors executing software instructions read from a memory or storage, or by combinations thereof. References to “processors” can refer to functionality, rather than any particular form of implementation. Processors can be dedicated hardware, or software-controlled programmable hardware. Moreover, several such processors can be implemented by a single programmable processor, performing multiple functions.

Software instructions for implementing the detailed functionality can be readily authored by artisans from the descriptions provided herein, e.g., written in C, C++, Visual Basic, Java, Python, Tcl, Perl, Scheme, Ruby, etc. Cell phones and other devices according to the present technology can include software modules for performing the different functions and acts.

Commonly, each device includes operating system software that provides interfaces to hardware devices and general purpose functions, and also includes application software which can be selectively invoked to perform particular tasks desired by a user. Known browser software, communications software, and media processing software can be adapted for many of the uses detailed herein. Software is commonly stored as instructions in one or more data structures conveyed by tangible media, such as magnetic or optical discs, memory cards, ROM, etc. Some embodiments may be implemented as embedded systems—a special purpose computer system in which the operating system software and the application software is indistinguishable to the user (e.g., as is commonly the case in basic cell phones). The functionality detailed in this specification can be implemented in operating system software, application software and/or as embedded system software.

While this specification earlier noted its relation to previous patent applications by the present assignee, it bears repeating. These disclosures should be read in concert and construed as a whole. Applicants intend that features in each be combined with features in the others. Thus, for example, the processing arrangements detailed in application Ser. No. 12/484,115 can be used in implementing the presently-detailed technology.

To provide a comprehensive disclosure without unduly lengthening this specification, applicants incorporate by reference the documents and patent disclosures referenced above. (Such documents are incorporated in their entireties, even if cited above in connection with specific of their teachings.)

The particular combinations of elements and features in the above-detailed embodiments are exemplary only; the interchanging and substitution of these teachings with other teachings in this and the incorporated-by-reference documents are also expressly contemplated and intended.

We claim:

1. A method comprising the acts:
with a mobile phone, obtaining identification information corresponding to a device, the device being selected from the group consisting of: a thermostat, a parking meter, and an alarm clock:
by reference to the identification information, identifying application software corresponding to said device;
downloading the identified application software to the mobile phone, from a repository remote from the device; and
through use of said application software, interacting with the device;
wherein the mobile phone serves as a multi-function controller—adapted to control a particular device through use of application software identified by reference to information corresponding to that device.

2. The method of claim 1, wherein the act of obtaining identification information comprises capturing image data from the device, and the method further includes:
decoding steganographically encoded digital watermark data from the captured image data; and
presenting a user interface for the device as a graphical overlay on the captured image data.

3. The method of claim 1, wherein the presenting includes presenting features of the user interface in registered alignment with features of the captured image data, by reference to the steganographically encoded digital watermark data.

4. The method of claim 1 that includes, with a mobile phone, obtaining identification information corresponding to a thermostat.

5. The method of claim 1 that includes, with a mobile phone, obtaining identification information corresponding to a parking meter.

6. The method of claim 1 that includes, with a mobile phone, obtaining identification information corresponding to an alarm clock.

7. The method of claim 1 that includes, with a mobile phone, obtaining identification information corresponding to a vehicle.

8. A method comprising:
through a user interface on a user's cell phone, receiving an instruction relating to control of a device, the user interface being presented on a screen of the cell phone in combination with a cell phone-captured image of the device;
signaling information corresponding to the instruction, to the user, in a first fashion while the instruction is pending; and
signaling information corresponding to the instruction, to the user, in a second, different fashion once the instruction has been successfully performed.

9. A method comprising:
while a user is in physical proximity to a device, initializing a transaction with the device, using a user interface presented on a screen of a user cell phone;
later, using the cell phone for a purpose unrelated to the device; and
still later, recalling the user interface to engage in a further transaction with the device.

10. The method of claim 9, wherein the device comprises a parking meter.

11. The method of claim 9, wherein the device comprises a thermostat.

12. A mobile phone including a processor, a wireless interface, a memory, a sensor, and a display, instructions in the memory configuring the processor to present a user interface that allows a user to select between several other device-specific user interfaces stored in memory, for using the mobile phone to interact with plural different external devices.
